(19) United States
(12) Patent Application Publication
(10) Pub. No.: US 2018/0020703 A1
(43) Pub. Date: Jan. 25, 2018

(54) METHOD FOR THE HIGH-PRESSURE TREATMENT OF A PRODUCT

(71) Applicants: Uhde High Pressure Technologies GmbH, Hagen (DE); ThyssenKrupp AG, Essen (DE)

(72) Inventors: Wilfried Knauf, Herdecke (DE); Peter Nünnerich, Siegen (DE)

(73) Assignees: Uhde High Pressure Technologies GmbH, Hagen (DE); ThyssenKrupp AG, Essen (DE)

(21) Appl. No.: 15/535,751

(22) PCT Filed: Dec. 1, 2015
(86) PCT No.: PCT/EP2015/078161

§ 371 Date: Jun. 14, 2017

(30) Foreign Application Priority Data
Dec. 17, 2014 (DE) 10 2014 118 876.4

(51) Int. Cl. A23L 3/015

(52) U.S. Cl. CPC A23L 3/015; A23V 2002/00

(57) ABSTRACT

A method for the high-pressure treatment of a product, such as packaged food, for example, may involve subjecting the product to a pressure medium in a high-pressure chamber and then lowering the pressure built up in the high-pressure chamber. The lowering of the pressure may take place in one or more phases, and at least in one of the phases the lowering of the pressure is controlled based on a second parameter, which is determined based on a first parameter recorded during pressure buildup. A system for performing such high-pressure treatment may generally include a first device for supplying a pressure chamber with a high-pressure medium and a second device for lowering the pressure in the pressure chamber.

The invention relates to a method for the high-pressure treatment of a product, in particular packaged food, wherein, in a first method step, the product is subjected to a pressure medium in a high-pressure chamber, wherein, in a subsequent method step, the pressure built up in the high-pressure chamber is lowered again, wherein the lowering of the pressure takes place in one or more phases and wherein, at least in one of the phases, the lowering of the pressure is cut back in a controlled manner. The invention also relates to a system for the high-pressure treatment of a product.

High-pressure treatments are nowadays used in various application areas. One of these is the compacting of ceramic or metallic powders (CIP). This involves batches of powder particles being pressed compactly in a high-pressure chamber, so that subsequently the compact has the characteristics of a brittle material and, if treated appropriately carefully, retains the form that it assumed during the pressing operation.

In the meantime, high-pressure treatment is also used in the food industry. For many foods, product packages that are intended to prevent, or at least delay, losses in quality are usually designed. However, the products may come into contact with harmful substances or microbes already before or during the packaging process. These are then packed along with the product and attack it within the package. Even before the high-pressure treatment was introduced, many methods had been developed to at least hold back this process. Just by way of example, mention may be made here of packaging under an inert-gas atmosphere, vacuum packaging or the pasteurization of the food in the package.

In the case of the high-pressure treatment of foods, the packaged product is exposed over a certain time period to very high pressures, for example between 200 and 600 MPa. Among the effects on the microorganisms that are present in and on the food is a disintegration of the cell membrane. The disintegration has the consequence that the microorganisms are killed off. On the other hand, smaller structures, such as vitamins, flavorings or nutrients, are largely preserved. As compared with conventional pasteurization by means of heat, high-pressure treatment consequently has the advantage of neither changing the flavor too much nor reducing the vitamin content excessively.

In the case of the high-pressure treatments described here, it should be noted that the pressure buildup is relatively uncritical, but the pressure reduction in many cases comprises a range in which an overly rapid pressure reduction may lead to the product or the package being damaged.

The damage is caused by physical processes, which differ according to the application area and product. For example, in the case of the compaction of powders, air that is present between the powder grains during the pressure buildup is trapped in the compact and compressed. During the pressure reduction, the trapped air expands and leaves the compact. If the air expands more quickly than it can escape from the compact, this inevitably leads to the product being damaged.

In the case of packaged foods, the high pressures have the effect that the gases or substances surrounding the food can diffuse into the product and/or the package. If the pressure is reduced again, as from a certain pressure level the opposite process occurs. With an overly rapid pressure reduction, the trapped gases may however not diffuse quickly enough out of the product and/or package and, by their expansion, lead to the formation of bubbles on the product or to the packaging film being damaged, for example by delamination thereof.

In order to avoid such damage, DE 10 2009 042 088 proposes a method for the high-pressure treatment of products in which the pressure reduction is divided into various phases. In a first uncritical phase, the pressure reduction takes place in an uncontrolled manner, while in a then following second phase the pressure reduction takes place by means of an actuating element that can be controlled by way of a pressure sensor.

However, such a system with its purely reactive control only achieves the desired pressure reduction rate inaccurately. In addition, the quality of the control is also greatly dependent on the composition of the product, on the amount of product there is in the container and in particular on the amount of gas. The necessary reproducibility of the aforementioned high-pressure treatment is therefore only unsatisfactorily ensured.

The object of the invention is to propose a method for the high-pressure treatment of a product in which the quality of the control and the reproducibility of the pressure reduction, or the lowering of the pressure, is improved. A further object of the invention is to propose a corresponding device.

These objects are achieved by the method with the features according to claim 1 and the system according to claim 11. The basic concept of the invention provides that a second parameter, in particular the volume of the pressure medium that has to be let out of the high-pressure chamber to achieve a certain pressure difference, is used for controlling the lowering of the pressure. The second parameter is consequently used for activating one or more means for pressure reduction and serves the purpose of achieving a desired pressure-time curve during the pressure reduction. The second parameter is determined on the basis of a mathematical model by means of a first parameter recorded during the pressure reduction. The first parameter in this case characterizes the behavior of the pressure in dependence on the amount of a high-pressure medium fed to the pressure chamber, in particular the volume or mass of the high-pressure medium required for the pressure buildup. According to the invention, consequently, additional values are used along with the data that are normally used for the control, for example the known or previously measured characteristic curves of the control valve or valves and the current pressure in the system. These additional values are based on a measurement during the pressure buildup phase.

The invention thereby makes use of the fact that the high-pressure chamber is a closed system, so that disturbances acting from outside have virtually no influence on the system parameters. Moreover, the high-pressure treatment described here is a batchwise process, in which the boundary conditions during the pressure buildup and pressure reduction remain at least substantially unchanged for the batch respectively considered. The first parameter and the second parameter can accordingly be set in relation to one another even though they act oppositely.

The first parameter, determined by means of a measurement during the pressure buildup, can consequently be used to predict or estimate a second parameter, acting oppositely during the pressure reduction. To be more precise, on the basis of a first value measured at a point or for a segment along the pressure buildup curve, the second value to be expected for the corresponding point or segment of the pressure reduction curve can be determined. Of course, the first parameter does not necessarily have to be a measured value, but may also be determined by interpolation.

The correlation between the first parameter and the second parameter is then used to predict by means of a mathematical model the second value to be expected and use it for controlling the pressure reduction. With its help, the degree of adjustment of the means for the controlled pressure reduction that is required for the desired rate of the pressure reduction, that is to say the desired pressure difference per unit of time, is set and possibly corrected. As a result, a higher quality of the control and greater reproducibility are achieved in comparison with a control of the aforementioned type. The means for the controlled pressure reduction is preferably a control valve and is also referred to as such hereinafter.

A system for the high-pressure treatment of a product that is suitable for the control described comprises a first device for supplying the pressure chamber with a high-pressure medium and a second device for lowering the pressure in the pressure chamber. In this case, the second device comprises at least one means for the controlled pressure reduction and a controller. The controller comprises a data processing device for controlling the at least one control valve. According to the invention, the first device comprises a measuring device, which is connected by way of a data link to the data processing device for controlling the at least one control valve. By way of the data link, the first parameter, measured during the pressure buildup, is transmitted to the data processing device and can be converted by the latter into the second parameter, which is used for controlling thedecompression.

One particular advantage of the system according to the invention is that already existing high-pressure systems with high-pressure chambers can be upgraded without any great effort. All that is required for this is to add a device for measuring the first parameter, establish a data link between the measuring device and the data processing device for controlling the at least one controllable means and create a programming of the control according to the invention in the data processing device, or the control unit for controlling the pressure reduction in the high-pressure chamber.

In the case of the control described here, it is advantageous in particular that it can not only be used for a specific product, but can be used generally in batchwise high-pressure processes. It is of particular advantage that the comparability of the first parameter and the second parameter is substantially independent of the product and the degree of filling in the high-pressure chamber, and also the structural design thereof. It is additionally not just suitable for a certain critical pressure range during the pressure reduction, but can in principle be carried out for any phase of the pressure reduction.

The control according to the invention of the pressure reduction with the aid of the second parameter in this case comprises the following steps. Before beginning the lowering of the pressure in the high-pressure chamber, the decompression curve suitable for the product is preset, that is to say the desired variation over time of the pressure reduction is defined. If no suitable decompression curve is known as yet, it must be determined experimentally. Then, a degree of opening is determined for the at least one control valve by using its control characteristics and the second parameter, a degree of opening with which the desired variation over time of the pressure reduction can be achieved. After the start of the pressure reduction, the current pressure in the high-pressure chamber or between the pressure chamber and the control valve is measured by means of pressure sensors and its variation is ascertained. If a setpoint/actual-value comparison that is performed finds a deviation, the valve position is correspondingly corrected. The correction is performed by analogy with what has been said above, that is to say while taking into account the value of the second parameter relevant to the range of the decompression curve. The control is consequently preferably performed on the basis of a parameter field, the parameter field comprising a plurality of second parameters that are respectively representative of a certain segment of the pressure reduction. Depending on the problem addressed, it may be advantageous to use a multidimensional parameter function for the control instead of a parameter field.

If the preset decompression curve provides changes of the pressure gradient, it is advantageous if the setpoint/actual-value comparisons are performed at these points of the decompression curve. In order to be able to estimate the representative values, the pressure buildup is divided into corresponding segments, for which a corresponding value of the first parameter is respectively read out. In this way, the respective value of the second parameter can be predicted and set in relation to the segment appropriate for it of the characteristic curve of the control valve or valves. The degree of opening of the control valve with which the desired pressure difference per unit of time can be reduced can then be determined from the characteristic curve. If the characteristic curve is not available, the control valve or valves is/are measured in order to obtain the respective adjustment values.

The parameter field in this way defines a number of target points on the preset decompression curve. If no value of the first parameter has been determined for one of the target points chosen, the value of the target point can be calculated without any problem by interpolation along the decompression curve.

If, when reaching a target point, the setpoint/actual-value comparison finds a deviation, the degree of opening of the control valve is adapted in order to change the gradient of the pressure reduction in such a way that the next-following target point or the next interpolation point is reached more accurately. In the case of this control it is advantageous if the pressure gradient for the next time segment cannot be changed arbitrarily. For this purpose, it is ensured that, even after the adaptation of the degree of opening, the pressure reduction curve follows a path within a preset target corridor. The target corridor thereby defines the range of a deviation of the decompression curve that is still suitable for the product. If the target corridor is not known, it can be determined experimentally.

If, for example, an adaptation would lead to the pressure gradient taking such a steep path in the next time segment that the product may be damaged, this is detected and the control is adapted in such a way that the pressure gradient follows a path within the target corridor. To this extent, it is not an obligatory aim of the control to reach the next target point on the pressure buildup curve exactly. In this way, damage to the product can be ruled out even better.

The mass or the volume of the pressure medium that is required to achieve a certain pressure difference during the pressure buildup is preferably measured as the first parameter. If, during the pressure buildup phase, the pressure increase is determined in dependence on the volume pumped into the high-pressure chamber, the measured pressure gradients form a pressure-volume curve. Transposing it onto the phase of the pressure reduction makes it possible to predict how much volume of the pressure medium must be let out of the system again in order to obtain a certain pressure difference. The same applies correspondingly to the alternative to this of measuring the mass of the pressure medium. It is of particular advantage in this respect to measure the respective mass flow or volume flow.

It is of particular advantage if, during the pressure buildup, the number of pump strokes that are required to achieve a certain pressure difference is counted. Multiplied by the volume per stroke, the volume of the pressure medium that must be pumped into the high-pressure chamber to achieve the certain pressure difference can be calculated quite easily. Of course, the number of pump strokes does not mean only complete strokes, but also includes the fragments corresponding to a section of the piston.

In an embodiment that is an alternative to this, the measuring device comprises a dynamic volume measuring device. The volume of the pressure medium pumped for a certain pressure difference can be measured in a particularly easy way by means of a flow sensor (flowmeter).

In a further alternative embodiment, the measuring device comprises a dynamic mass measuring device.

The measurement result is then used to determine the expansion volume required for the desireddecompression. For this, the expansion volumes for certain pressures and degrees of opening of the control valve are read out from the characteristic curves of the control valve or valves and, as a consequence thereof, the required degree of opening for the desired pressure reduction per unit of time is predicted.

In a preferred embodiment, the second parameter is allocated at least one correction factor or relaxation factor. This allows inertias that are brought about for example by diffusion processes occurring during the pressure reduction to be taken into account in the control. The time-dependent effects occurring are eliminated by correction factors, in particular variable correction factors, which can be determined from setpoint-actual-value comparisons of the pressure during the pressure reduction. The elimination of the deviation occurring due to different diffusion processes ensures an exact control of the pressure reduction even in the case of frequently changing products or packages.

A preferred embodiment of the control according to the invention with its respective method steps is described below:

The variation over time of the pressure gradient required for the desired rate of lowering the pressure presets a decompression curve, which is intended to be traced as accurately as possible by means of the control. For accurate control, the expansion volume to be expected for a certain pressure reduction is used.

For the model-based estimation of the expansion volume, the volume of the pressure medium that is required for a certain pressure buildup in the high-pressure chamber is measured. This results in a pressure-volume curve that depicts the pressure buildup. The associated function is calculated during the pressure buildup and recorded as an array. The array contains the measured values for individual points of the pressure buildup and also the associated derivative. The calculated values can, as already explained, be converted into a pressure-volume curve for the pressure reduction, or an expansion function.

The decompression curve required for decompression without any damage is depicted as an decompression function. This is used to produce an interpolation point array, the interpolation points preferably being set to points of the function at which the pressure gradient is to be changed during the controlleddecompression. The respective target points of the pressure reduction curve should consequently be set in such a way that they depict the variation over time of the pressure gradient as well as possible. If desired, the interpolation points may also be interpolated as a continuum along the pressure reduction curve.

Accordingly, an array that is based on the control characteristics of the control valve or valves and the second parameter in the form of the expansion volume to be expected as input values is produced for the controller. The required degree of opening with which the required expansion volume can be let out of the high-pressure chamber in the desired unit of time is read out from the valve characteristic curve. With the degree of opening thus determined, the controlled decompression is started. A setpoint/actual value comparison is respectively performed at the interpolation points. The correction of the valve position that may be required after a setpoint/actual-value comparison is in turn performed while taking into account the expansion volume to be expected for the next time segment. The calculation is preferably performed by means of approximation. The correction can be calculated particularly easily by way of a linear approximation. Depending on the application, however, complex approximations may also be used. Of course, it is conducive to the control described here if the at least one control valve for this can be set infinitely variably.

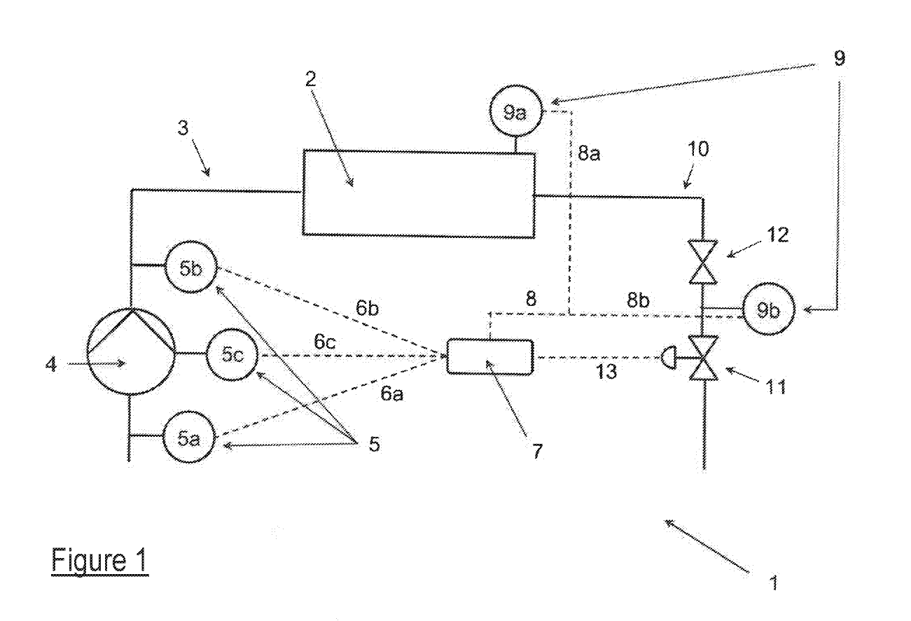

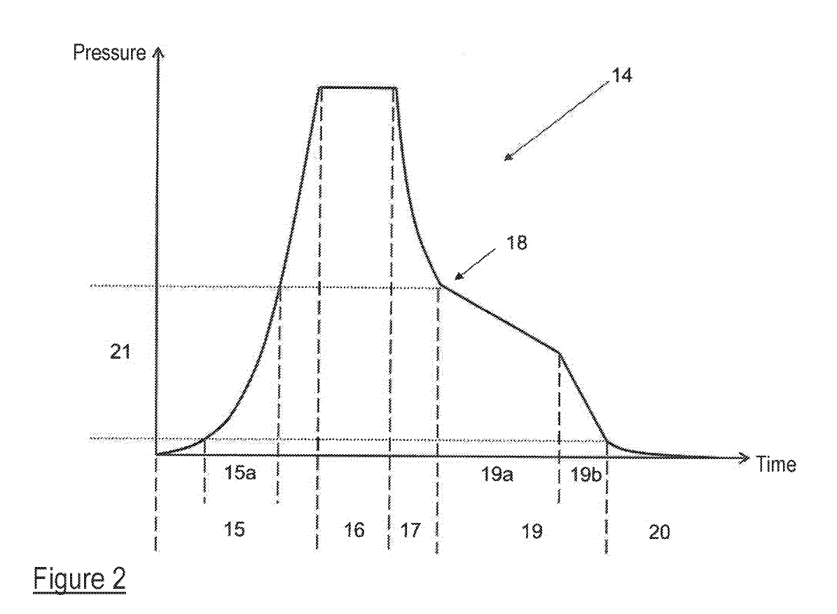

The invention is explained further on the basis of two figures. Of these, FIG. 1 shows an embodiment of the system according to the invention for the high-pressure treatment of a product in a schematic representation. With FIG. 2, a pressure variation controlled with the aid of the method according to the invention is explained by way of example.

The system 1 for the high-pressure treatment of a product comprises a high-pressure chamber 2, which is connected by way of a pressure line 3 to a high-pressure pump 4 and is supplied by the latter with a high-pressure medium. A measuring device 5 is arranged on the pressure line 3 in positions that are an alternative to one another in the direction of flow of the pressure medium, either in a position upstream 5a or downstream 5b of the high-pressure pump 4. As an alternative to this, as shown in the position 5c, it may be arranged on the high-pressure pump 4 itself. The measuring device 5 measures the amount of the high-pressure medium, in particular the mass or volume thereof, that flows through the pressure line 3 or is delivered by the high-pressure pump 4. The measuring device 5 transmits these values by way of the first data link 6a, 6b 6c, representated here by dashed lines, to a data processing device 7.

The data processing device 7 is connected by way of a second data link 8, likewise represented by dashed lines, to a pressure sensor 9. The pressure sensor 9 may be connected directly 9a to the high-pressure chamber 2 and/or be arranged indirectly 9b on a pressure line 10, which connects the pressure chamber 2 to a control valve 11. Provided between the pressure chamber 2 and the control valve 11 is a shut-off valve 12, which seals off the pressure chamber 2 from the control valve 11. The control valve 11 is connected by way of a third data link 13, in turn represented by dashed lines, to the data processing device 7 and is activated thereby.

FIG. 2 shows a line diagram 14, with which the variation in pressure over time in the high-pressure chamber 2 is explained by way of example. In a first phase 15 of the pressure buildup, the rise in pressure per unit of time increases with increasing compression in the high-pressure chamber 2. Once the desired pressure has been reached, there follows a second phase 16, the so-called plateau phase, in which the pressure is maintained and acts in a desired way on the product located in the high-pressure chamber 2.

This is followed by the decompression, beginning with a third phase 17, in which the pressure is reduced in an uncontrolled manner up until the starting point of the controlled decompression 18. The then following fourth phase 19 of the controlled decompression is divided into a segment 19a of lower pressure reduction and a segment 19b of greater pressure reduction. At the beginning of the fourth phase 19, the control valve 11 is set to the degree of opening estimated according to the invention. During the decompression, the degree of opening may be readjusted by using the second parameter. The phase 19 is occupied with any desired number of target points, that is to say with any desired number of setpoint/actual-value comparisons, which are taken as a basis for the control according to the invention. The phase 19 of controlled decompression goes over into a phase 20, in which the residual pressure that is still in the pressure chamber is relieved.

The pressure range 21 passed through during the fourth phase 19 is the pressure range preferred for the determination of the first parameter during the pressure buildup. The pressure range 21 may consequently be included in a segment 15a of the first phase 15.

If two pressure sensors 9a, 9b are provided, they are connected by way of the data links 8a and 8b, respectively, to the data processing device 7. In this variant, it is advantageous to connect the pressure sensor 9b, which is indirectly connected to the high-pressure chamber 2 and is between the control valve 11 and the shut-off valve 12, to the pressure line 10. In this variant, the pressure sensor 9b is disconnected from the high-pressure chamber 2 by the shut-off valve 12 during the phases 15, 16 and 17 and is only connected to the pressure chamber 2 as from the starting point 18 of the controlled decompression. As a result, an instrument for a lower pressure range, and consequently with a higher accuracy, can be used for the sensor 9b. It should be noted that, in the case of high throughflows, in particular the associated high pressure gradients, the pressure value measured at 9b deviates significantly from the pressure in the high-pressure chamber 2 as a result of the pressure loss in the pressure line 10. The pressure sensor 9a may then be used for these cases in order to correct the pressure value measured at 9b and increase the stability of the control.

1.-14. (canceled)

15. A method for high-pressure treatment of a product, the method comprising:
subjecting the product to a pressure medium in a high-pressure chamber;
lowering a pressure built up in the high-pressure chamber in one or more phases, wherein the lowering of the pressure is controlled in at least one of the phases; and
determining as a first parameter either a mass or a volume of the pressure medium required to achieve a certain pressure difference during a pressure buildup in the high-pressure chamber,
wherein a second parameter that is determined by way of the first parameter is used for control of the lowering of the pressure in the high-pressure chamber in the at least one of the phases.

16. The method of claim 15 wherein the second parameter is a volume of the pressure medium that is released from the high-pressure chamber to achieve a certain pressure difference.

17. The method of claim 15 wherein control of the lowering of the pressure in the high-pressure chamber is performed based on a parameter field comprising a plurality of second parameters that are each representative of a segment of a pressure reduction.

18. The method of claim 15 further comprising counting a number of pump strokes required to achieve the certain pressure difference during the pressure buildup in the high-pressure chamber.

19. The method of claim 15 further comprising allocating the second parameter at least one correction factor.

20. The method of claim 15 further comprising transmitting the first parameter, which is recorded during the pressure buildup, to a data processing device controlling the lowering of the pressure.

21. The method of claim 15 wherein at a beginning or during the at least one of the phases in which the lowering of the pressure is controlled a degree of adjustment with which a desired variation over time of a pressure reduction can be achieved is determined for a means of pressure reduction by using the second parameter.

22. The method of claim 15 wherein as the pressure built up in the high-pressure chamber is lowered during a pressure reduction either the pressure in the high-pressure chamber or a pressure between the high-pressure chamber and a means for pressure reduction is measured by a pressure sensor, wherein the method further comprises performing a correction of the pressure reduction if there is a deviation between a desired variation over time of the pressure reduction and the measured pressure.

23. The method of claim 15 wherein as the pressure built up in the high-pressure chamber is lowered during a pressure reduction either the pressure in the high-pressure chamber or a pressure between the high-pressure chamber and a means for pressure reduction is measured by a pressure sensor, wherein the method further comprises performing a correction of the pressure reduction if there is a deviation between a desired variation over time of the pressure reduction and a measured pressure variation over time.

24. The method of claim 15 wherein control of the lowering of the pressure in the high-pressure chamber follows a path within a target corridor.

25. A system for high-pressure treatment of a product, the system comprising:
a first device for supplying a pressure chamber with a high-pressure medium, the first device comprising a measuring device;
a second device for lowering a pressure in the pressure chamber, the second device comprising a means for pressure reduction and a data processing device connected via a first data link to the means for pressure reduction, wherein the measuring device is connected via a second data link to the data processing device for controlling the means for pressure reduction, wherein the measuring device is disposed on a pressure line in a direction of flow of the high-pressure medium either upstream or downstream of a high-pressure pump or is disposed on the high-pressure pump; and
a third data link connected to a pressure sensor that is either connected directly to the pressure chamber or disposed indirectly on a pressure line that connects the pressure chamber to a control valve, wherein a shut-off valve is disposed between the pressure chamber and the control valve, wherein the shut-off valve seals off the pressure chamber from the control valve, wherein the control valve is connected by way of the first data link to the data processing device and is activated by the data processing device.

26. The system of claim 25 wherein the measuring device comprises a dynamic volume measuring device.

27. The system of claim 25 wherein the measuring device comprises a dynamic mass measuring device.

28. The system of claim 25 wherein the measuring device comprises a sensor for recording pump strokes of the high-pressure pump supplying the pressure chamber.
